(19) United States
(12) Patent Application Publication
(10) Pub. No.: US 2007/0294344 A1
(43) Pub. Date: Dec. 20, 2007

(54) Automatic scheduling system

(75) Inventor: Prabhuram Mohan, San Jose, CA (US)

Correspondence Address: Welsh & Katz, Ltd.;Jon P. Christensen, 22nd Floor, 120 South Riverside Plaza, Chicago, IL, 60606, US

(73) Assignee: Aspect Software

(21) Appl. No.: 11/452,529

(22) Filed: Jun. 14, 2006

(51) Int. Cl. G05B 19/418; G06F 15/16; G06F 9/46

(52) U.S. Cl. 709/204; 705/8

(57) ABSTRACT

A method and apparatus are provided for scheduling conferences between a client and one of a plurality of knowledge workers of an organization. The method includes the steps of each of the plurality of knowledge workers providing one or more time intervals when the knowledge worker is available for conferences and consolidating the provided time intervals of the knowledge workers into a knowledge worker schedule located within a computer. The method further includes the steps of the client accessing the knowledge worker schedule and selecting an available time interval for a conference from within the knowledge worker schedule and the computer selecting a knowledge worker of the plurality of knowledge workers for a conference with the client based upon the selected time interval.

### FIELD OF THE INVENTION

The invention relates to conferences and more particularly to methods of scheduling conferences.

### BACKGROUND OF THE INVENTION

Methods of scheduling conferences between knowledge workers (e.g., stockbrokers, financial analysts, social services worker, etc.) of an organization and the organization's prospective clients are generally accomplished on an ad-hoc basis. Clients are often provided with a telephone number of the organization and encouraged to call the organization.

A telephone operator may answer the calls and attempt to match the needs of the client with the availability of the knowledge worker. Typically, the process involves the operator calling the knowledge workers, one-at-a-time, to determine availability.

Often the process is accomplished on an immediate need basis. When the client calls, the operator will attempt to find a knowledge worker who can interrupt whatever he/she is doing to converse with the client.

When there are no knowledge workers available for a conversation, the operator may request a telephone number from the client and promise that a knowledge worker will call the client back within some time period. The operator may give the telephone number to a knowledge worker and assume that a return call has been made

In response, the knowledge worker may attempt to contact the client. However, if the client is now busy, the knowledge worker may make several attempts to contact the client and then give up if no contact is established. Alternatively, if the knowledge worker is busy or distracted and the knowledge worker is not able to return the call immediately, then the request may be misplaced or lost. Because of the importance of communication between knowledge workers and potential clients, a need exists for a better method of scheduling conferences between clients and knowledge workers.

### BRIEF DESCRIPTION OF THE INVENTION

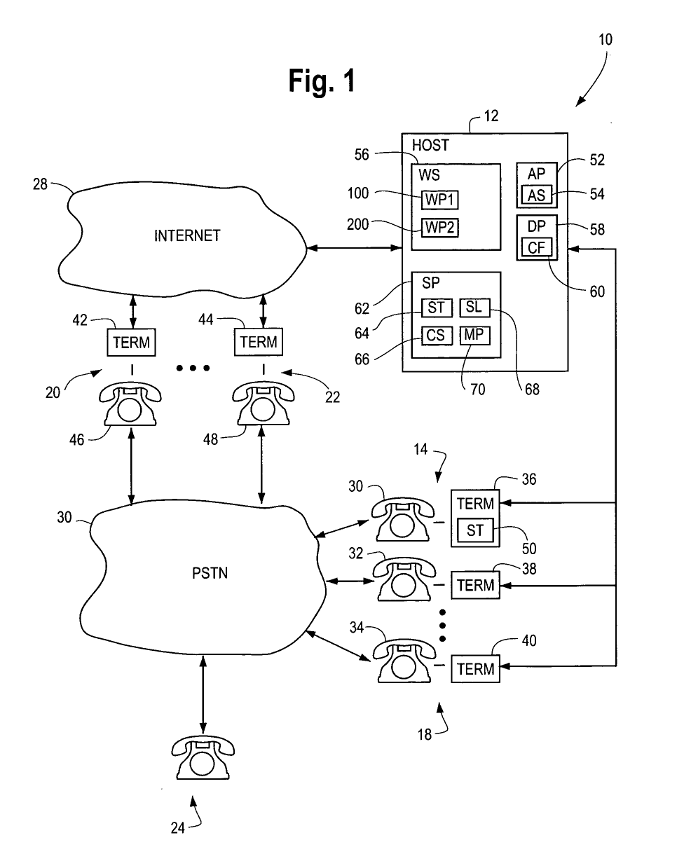

FIG. 1 depicts an apparatus for scheduling conferences between knowledge workers and clients in accordance with illustrated embodiments of the invention;

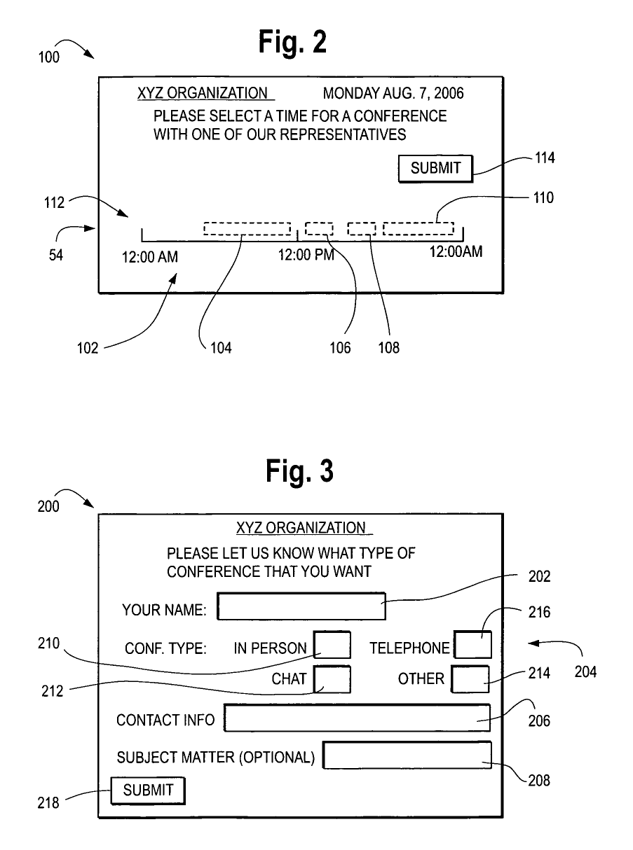

FIG. 2 depicts a conference time selection window that may be used by the system of FIG. 1; and

FIG. 3 depicts a query window that may be used by the system of FIG. 1.

### SUMMARY

A method and apparatus are provided for scheduling conferences between a client and one of a plurality of knowledge workers of an organization. The method includes the steps of each of the plurality of knowledge workers providing one or more time intervals when the knowledge worker is available for conferences and consolidating the provided time intervals of the knowledge workers into a knowledge worker schedule located within a computer. The method further includes the steps of the client accessing the knowledge worker schedule and selecting an available time interval for a conference from within the knowledge worker schedule and the computer selecting a knowledge worker of the plurality of knowledge workers for a conference with the client based upon the selected time interval.

### DETAILED DESCRIPTION OF AN ILLUSTRATED EMBODIMENT

FIG. 1 is a block diagram of a system 10 used by an organization for scheduling conferences between knowledge workers and clients under an illustrated embodiment of the invention. Included within the system 10 may be a host computer 12 that coordinates and controls the scheduling of conferences.

Associated with the organization may be a group of knowledge workers, working at work stations 14, 16, 18. For simplicity, reference numbers 14, 16, 18 may hereinafter be used to refer to the knowledge workers at their work stations.

Each work station 14, 16, 18 may include a telephone 30, 32, 34 and a computer terminal 36, 38, 40. In general, knowledge workers 14, 16, 18 may communicate with clients 20, 22, 24 on a face-to-face basis, through the Internet 28 or through the public switched telephone network (PSTN) 30.

At least some of the clients 20, 22 may have access to the organization through a respective computer 42, 44 and telephone 46, 48. Other clients may have access to the organization only by telephone 24. (As above, reference number 24 may hereinafter be used to refer to the client using the telephone 24.)

In order to insure the availability of knowledge workers 14, 16, 18 for purposes of serving the needs of clients 20, 22, 24, the organization may require that the knowledge workers 14, 16, 18 provide indication of their availability for conferences with customers 20, 22, 24. In accordance with the requirement, knowledge workers 14, 16, 18 may activate a scheduling tool 50 (e.g., OUTLOOK, lotus notes, Sun Office, etc.) within their terminals 36, 38, 40 and prospectively enter time intervals (identify time periods) when the knowledge worker 14, 16, 18 will be available for conferences with clients 20,22, 24. The time intervals entered by knowledge workers may be entered under any format (e.g., one-half hour increments, one-hour increments, four-hour increments, etc.) along with the start and end times and date of each interval.

Periodically, an availability processor 52 within the host 12 may access the terminals 36, 38, 40 of the knowledge workers 14, 16, 18 and retrieve the conference time intervals entered by the knowledge workers 14, 16, 18. Upon retrieving the conference intervals entered by the respective knowledge workers 14, 16, 18, the availability processor 52 may assemble and consolidate the conference intervals from the respective knowledge workers 14, 16, 18 into a knowledge worker schedule 54 located within the host 12.

In order to facilitate the objectives of the organization, the organization may maintain a website 56 within the host 12. Copies of the schedule 54 may be downloaded by clients 20, 22.

As clients 20, 22 access the website 56, a home page may be downloaded to the client 20, 22. Shown on the home page may be descriptive information about the organization and an icon that identifies the schedule 54 of worker availability for conferences. When a client 20, 22 selects the schedule 54, the client 20, 22 may be presented with a calendar that shows a current month along with forward and back buttons (softkeys) that allow the client 20, 22 to move to future months or return to a current month.

The client 20, 22 may use the forward or backward buttons to select an appropriate month and place a cursor over the appropriate day of the month. The client 20, 22 may then activate a switch associated with the cursor to select that day.

In response, a display processor 58 within the host 12 may retrieve the schedule 54 for that month and day and download the schedule 54 to the terminal 42, 44 of the requesting client 20, 22 within a scheduling window 100. The schedule 54 may be presented as a simple time line 102 or as a series of contiguous or non-contiguous time blocks 104, 106, 108, 110 that correspond to the available conference times and time intervals provided by the workers 14, 16, 18.

In order to request a conference with a worker 14, 16, 18, the client 20, 22 may drag his cursor 112 along the time line 102 while activating a switch associated with the cursor 112 or select one or more blocks within the schedule 54 by placing the cursor 112 over a block and activating the switch. Once an appropriate conference time has been selected, the client 20, 22 may activate a SUBMIT button (softkey) 114.

In response, the display processor 58 may open a conference file 60. The selected month, day and requested time for the conference may be stored within the conference file 60. The conference file 60 may be identified by any appropriate identifier (e.g., the internet address of the terminal 42, 44 from which the conference request originated).

The display processor 58 may also download a query window 200 to the client 20, 22. Within the query window 200, the requesting client 20, 22 may be asked to enter the client's name, a conference type 204 and contact information with respective windows 202. A first window 202 may be provided where the client 20, 22 may enter his/her name.

The client 20, 22 may also be asked to select any of a number of real time conference types 204. Real time, in this case, means that the exchange of information between the client 20, 22 and worker 14, 16, 18 occurs in real time without significant delays.

As one example of a conference type 204, the client 20, 22 may select the IN PERSON softkey 210. In this case, the client 20, 22 would travel to a location of the worker 14, 16, 18 for a fact-to-face meeting.

Alternatively, the client 20, 22 may select the TELEPHONE softkey 216, the CHAT softkey 212 or the OTHER softkey 214. The OTHER softkey 214 may be any other conference type accepted by the organization (e.g., the worker 14, 16, 18 travels to the location of the client 20, 22).

The client 20, 22 may also be asked to enter contact information through a CONTACT INFO window 206. Within the CONTACT INFO window 206, the client 20, 22 may enter information relevant to the contact type 204. For example, if the selected contact type 205 had been telephone 216, then the client 20, 22 would enter a telephone number into the window 206 where the client 20, 22 could be contacted. Similarly, if the selected contact type 205 had been CHAT 212, then the client 20, 22 would enter an Internet path identifier into the window 206 where the client 20, 22 could be contacted.

The client 20, 22 may also be asked to specify a subject matter within a SUBJECT MATTER window 208. If the organzation's workers 14, 16, 18 were stockbrokers, then the subject matter may be a type of stock in which the client 20, 22 has an interest. If the organzation's workers 14, 16, 18 were social workers, then the subject matter may be a type of social problem (e.g., drug abuse, divorce, etc.) in which the client 20, 22 has an interest.

As a final step, the client 20, 22 may activate a SUBMIT button (softkey) 218. Upon activating the SUBMIT button 218, the information entered through the query window 200 may be transferred back to the display processor 60. Within the display processor 60, the information entered through the query window 200 may be entered into the conference file 60.

In an alternative embodiment, the entries of the query window 200 may be automatically provided based upon past conferences. In this case, the display processor 58 may identify the client 20, 22 based upon the URL of the client 20, 22. In this case, upon selecting a time within the scheduling window 100, the display processor 58 may compare the URL of the requesting client 20, 22 with previous system users. If a match is found, then the entries of the query window 200 are automatically filled in with the entries from the query window 200 of a previous visit.

Upon saving the information from the query window 200 into the conference request file 60, the display processor 58 may transfer the conference request file 60 to a selection processor 62. Within the selection processor 62, the conference request may be matched with a worker 14, 16, 18.

In the simplest example, the selection processor 62 may simply search for the worker 14, 16, 18 with an available conference time that is at least partially coextensive with (i.e., is at least equal to or greater than) the requested conference time from a client (e.g., 20). In another example, the selection processor 62 may search for a worker 14, 16, 18 who has had the most recent contact with the client 20 and attempt to match the conference request with a schedule of that worker 14, 16,18. Once the selection processor 62 has identified a worker (e.g., 14), the selection processor 62 may enter the scheduled conference into a conference schedule 66 and use a host scheduling tool 64 to notify the worker 14 and to confirm the conference to the client 20.

The host scheduling tool 64 may be any software product (e.g., OUTLOOK) capable of sending a conference notification/confirmation (e.g., a MEETING INVITE) to the conference participants. It should be noted in this regard that the sending of a OUTLOOK MEETING INVITE to the worker 14 would also cause the scheduled conference to be entered by the worker scheduling tool 50 into the work schedule of the worker 14.

It should be noted that the client 20 is not notified of the identity of the worker 14 selected for the conference. The client 20 is not notified of the identity of the worker 14 because if the worker 14 should not be available at the scheduled time of the conference, then the selection processor 62 may automatically schedule another worker (e.g., 16) for the conference call without loss of functionality.

In this case, if the originally selected worker 14 should become aware of a scheduling conflict, then the worker 14 may cancel his scheduled conference by accessing his scheduling tool 50 and deleting the time interval for the scheduled conference. The availability processor 52 may detect this change by constantly comparing the times of any previously scheduled conferences for a worker 14 within the conference schedule 66 with the times entered within the scheduling tool 50 of the worker 14. If a difference should be detected, then the availability processor 52 may transfer the conference file 60 back to the selection processor 62 for selection of a new worker (e.g., 16).

Once the file 60 is received by the scheduling processor 62, a new worker 14, 16, 18 may be selected as discussed above. In this case, a MEETING INVITE is sent to the newly selected worker 14, 16, 18 without sending a new confirmation to the client 20.

If the selection processor 62 cannot locate another worker 14, 16, 18, then the selection processor 62 may send an e-mail to any available workers 14, 16, 18 asking for a volunteer during this unsupported conference time period. Volunteering, in this case, would involve a worker 14, 16, 18 changing the entries within his scheduling tool 50 to indicate availability during the conference time period. If a volunteer cannot be found, then the selection processor 62 may notify the client 20 (e.g., via e-mail) that the client 20 must select a new conference time period.

In any case, once the scheduled time of the conference arrives, the scheduling tool 50 may remind the worker 14, 16, 18 of the conference. Alternatively, the availability processor 52 may detect the impending conference and download a reminder along with the contents of the query window 200 to the selected worker 14, 16, 18. In response, the worker 14, 16, 18 may take steps to participate in the conference as requested by the client 20, 22.

If the client 20, 22 had requested a face-to-face conference, then the worker 14, 16, 18 may meet the client 20, 22, 24 as requested. If the requested conference had been by telephone, then the worker 14, 16, 18 may call the client 20, 22 at the provided number or initiate and participate in a CHAT session, all in accordance with the requrest and content of the query window 200.

In another embodiment, the client (e.g. 24) may only have access to a telephone 24. In this case, one of the work stations (e.g., 14) may also function as a system interface for scheduling conferences. In this case the worker 14 may answer the call from the client 24 through the telephone 30 and access the website 56 through the terminal 36 to retrieve the schedule 54. The worker 14 may explain the scheduling options from the schedule 54 to the caller 24 and accept a scheduling request verbally from the client 24. The worker 14 may also fill out the query window 200 by posing questions to the client 24 and entering answers into the blanks of the query window 200.

In this case, the client 24 may request either a face-to-face conference or a telephone conference. Once the conference has been set up by the worker 14, the conference may proceed substantially as discussed above.

In another embodiment, selection of a worker 14, 16, 18 may be based upon skill. In this case, the selection processor may be provided with a skills list 68 that summarizes the skills of each worker 14, 16, 18. The skills list 68 may be a list of key words used to describe certain abilities of the worker 14, 16, 18.

In this case, selection of a worker 14, 16, 18 may be based upon a two step process. As a first step, the selection processor 62 may transfer a content of the subject matter window 200 to a matching processor 70. The matching processor 70 may match the subject matter enter through the subject matter window 208 with the contents of the skills list 68 for the workers 14, 16, 18.

Based upon any matches the selection processor 62 may prepare a new time schedule 54 containing only the time entries of those workers 14, 16, 18 whose skills match the problem entered through the subject matter window 208. If a worker 14, 16, 18 is available within the newly prepared schedule 54 during the time originally selected by the client 20, 22, 24, then the process proceeds as discussed above.

If a worker 14, 16, 18 cannot be found within the newly prepared schedule 54, then a message may be returned to the client 20, 22, 24 informing him/her that a conference cannot be scheduled at the requested time. The scheduling processor 62 may also present the client 20, 22, 24 with the newly prepared schedule 54 showing only those entries from knowledge workers with the skill necessary for the subject matter requested by the client 20, 22, 24. The client 20, 22, 24 may select a new time from the new schedule 54 and the process may proceed as discussed above.

A specific embodiment of method and apparatus for scheduling a conference with a knowledge worker has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of scheduling conferences between a client and one of a plurality of knowledge workers of an organization comprising:
each of the plurality of knowledge workers providing one or more time intervals when the knowledge worker is available for conferences;
consolidating the provided time intervals of the knowledge workers into a knowledge worker schedule located within a computer;
the client accessing the knowledge worker schedule and selecting an available time interval for a conference from within the knowledge worker schedule; and
the computer selecting a knowledge worker of the plurality of knowledge workers for a conference with the client based upon the selected time interval.

2. The method of scheduling conferences as in claim 1 further comprising the computer notifying the selected knowledge worker of the conference during the selected time interval.

3. The method of scheduling conferences as in claim 1 wherein the time intervals provided by the plurality of knowledge workers further comprise at least some partially overlapping time intervals.

4. The method of scheduling conferences as in claim 1 further comprising the computer converting the knowledge worker schedule into a time line.

5. The method of scheduling conferences as in claim 4 wherein the step of the client selecting the time interval further comprises the client placing a cursor over the time line and dragging the cursor along the time line to select a time interval.

6. The method of scheduling conferences as in claim 1 wherein the step of selecting the agent further comprises the computer identifying at least one knowledge worker with a provided time interval at least a portion of which is coextensive with the selected time interval.

7. The method of scheduling conferences as in claim 6 further comprising the selected agent having a scheduling conflict with regard to the selected time interval and the computer selecting another knowledge worker for the conference with a provided time interval that is coextensive with the selected time interval.

8. The method of scheduling conferences as in claim 1 further comprising the computer sending a conference confirmation to the client and to the selected knowledge worker.

9. The method of scheduling conferences as in claim 1 further comprising the organization providing a website that displays the knowledge worker schedule.

10. The method of scheduling conferences as in claim 9 wherein the step of the client accessing the knowledge worker schedule further comprises the client accessing the website through an Internet connection.

11. The method of scheduling conferences as in claim 1 further comprising the client providing a subject matter of the conference.

12. The method of scheduling conferences as in claim 11 further comprising the computer selecting the agent based upon the provided subject matter of the conference.

13. An apparatus for scheduling conferences between a client and one of a plurality of knowledge workers of an organization comprising:
means used by each of the plurality of knowledge workers for providing one or more time intervals when the knowledge worker is available for conferences;
means for consolidating the provided time intervals of the knowledge workers into a knowledge worker schedule;
means used by the client for accessing the knowledge worker schedule and selecting an available time interval for a conference from within the knowledge worker schedule; and
means for selecting a knowledge worker of the plurality of knowledge workers for a conference with the client based upon the selected time interval.

14. The apparatus for scheduling conferences as in claim 13 further comprising means for notifying the selected knowledge worker of the conference during the selected time interval.

15. The apparatus for scheduling conferences as in claim 13 wherein the time intervals provided by the plurality of knowledge workers further comprise at least some partially overlapping time intervals.

16. The apparatus for scheduling conferences as in claim 13 further comprising means for combining the provided time intervals into a time line.

17. The apparatus for scheduling conferences as in claim 16 wherein the means used by the client for selecting the time interval further comprises a cursor that the client places over the time line and drags along the time line to select a time interval.

18. The apparatus for scheduling conferences as in claim 13 wherein the means for selecting the knowledge worker further comprises means for identifying at least one knowledge worker with a provided time interval at least a portion of which is coextensive with the selected time interval.

19. The apparatus for scheduling conferences as in claim 18 further comprising means within the computer for detecting cancellation of a conference by the selected knowledge worker and for identifying another knowledge worker with a provided time interval that is coextensive with the selected time interval.

20. The apparatus for scheduling conferences as in claim 13 further comprising means for sending a conference confirmation to the client and to the selected knowledge worker.

21. The apparatus for scheduling conferences as in claim 13 further comprising the organization providing a website that displays the knowledge worker schedule.

22. The apparatus for scheduling conferences as in claim 21 wherein the means used by the client for accessing the knowledge worker schedule further comprises an Internet connection that allows the client to access knowledge worker schedule through the website.

23. The apparatus for scheduling conferences as in claim 23 further comprising means for allowing the client to providing a subject matter of the conference.

24. The apparatus for scheduling conferences as in claim 13 further comprising means within the computer for selecting the agent based upon the provided subject matter of the conference.

25. An apparatus for scheduling conferences between a client and one of a plurality of knowledge workers of an organization comprising:
a computer;
a worker scheduling tool within a respective terminal of each of the plurality of workers for receiving one or more time intervals from the knowledge worker that identify when the knowledge worker is available for conferences;
an availability processor that consolidates the provided time intervals into a knowledge worker schedule located within the computer;
a terminal through which the client accesses the knowledge worker schedule and selects an available time interval for a conference from within the knowledge worker schedule; and
a selection processor within the computer for selecting a knowledge worker of the plurality of knowledge workers for a conference with the client based upon the selected time interval.

26. The apparatus for scheduling conferences as in claim 25 further comprising a host scheduling tool within the computer that notifies the selected knowledge worker of the conference during the selected time interval.

27. The apparatus for scheduling conferences as in claim 25 wherein the time intervals provided by the plurality of knowledge workers further comprise at least some partially overlapping time intervals.

28. The apparatus for scheduling conferences as in claim 25 wherein the knowledge workers schedule further comprises a time line.

29. The apparatus for scheduling conferences as in claim 25 further comprising a website through which the client accesses the knowledge worker schedule.

30. The apparatus for scheduling conferences as in claim 29 further comprising a query webpage through which the client enters a subject matter of the conference.

31. The apparatus for scheduling conferences as in claim 30 further comprising a selection processor that selects a knowledge worker based upon a skill of the knowledge worker in the entered subject matter.
